(19) United States
(12) Patent Application Publication
(10) Pub. No.: US 2026/0117081 A1
(43) Pub. Date: Apr. 30, 2026

(54) ELASTIC MATERIAL AND PREPARATION METHOD THEREFOR, LOUDSPEAKER, AND ELECTRONIC DEVICE

(71) Applicant: MERRY ELECTRONICS (SUZHOU) CO., LTD., Suzhou City (CN)

(72) Inventors: Huaming WAN, Suzhou City (CN); Mingya LUO, Suzhou City (CN); Guowei CHENG, Suzhou City (CN)

(73) Assignee: MERRY ELECTRONICS (SUZHOU) CO., LTD., Suzhou City (CN)

(21) Appl. No.: 19/070,706

(22) Filed: Mar. 5, 2025

(30) Foreign Application Priority Data
Oct. 29, 2024 (CN) 202411518269.9

(51) Int. Cl. C09D 7/40; C09D 1/00; C09D 7/20; C09D 7/61; H04R 31/00

(52) U.S. Cl. CPC C09D 7/67; C09D 1/00; C09D 7/20; C09D 7/61; C09D 7/70; H04R 31/00; H04R 2499/11

(57) ABSTRACT

Provided are an elastic material and a preparation method therefor and a loudspeaker and an electronic device. The elastic material comprises a carrying substrate, and a nanomaterial and a molecular sieve arranged inside pores of the carrying substrate; in the elastic material, the carrying substrate has a content of 97-99 wt %; a mass ratio of the nanomaterial to the molecular sieve is 1:0.9-1.1. The elastic material provided has a large specific surface area, which can effectively absorb noise, dissipate acoustic energy, and improve the efficacy of vibration and noise reduction; and by loading the nanomaterial and the molecular sieve, the shielding performance and signal output quality of the electronic device are improved, and the problem of reduced service life caused by unefficient heat dissipation of the electronic device is solved.

### CROSS-REFERENCE TO RELATED APPLICATION(S)

This application claims priority to Chinese Patent Application No. 202411518269.9 filed Oct. 29, 2024 the disclosure of which is incorporated herein by reference in its entirety.

### TECHNICAL FIELD

The present application belongs to the technical field of electronic acoustic materials, and specifically relates to an elastic material and a preparation method therefor, and a loudspeaker and an electronic device.

### BACKGROUND

Mobile phones, tablet computers, laptop computers and other electronic products become thinner and lighter, and accordingly the integration of internal parts and the size of tiny parts are required more strictly; meanwhile, problems such as heat generation and magnetic field interference arise therefrom.

Take the mobile phone as an example; its main problems include: (1) due to the thin and light design of mobile phone, the internal space is reduced, which means that the rear cavity volume of loudspeaker becomes smaller, F0 increases, and the low-frequency sensitivity decreases; (2) because the size of the mobile phone becomes smaller, heat is not timely dissipated, which causes the electronic products easy to be hot and results in serving-life reduction; (3) due to the thin and light design of mobile phone, the internal space of the mobile phone becomes smaller, various parts are compact in arrangement, and the signal/magnetic field is easy to be interfered.

In view of the above problems, currently, solutions in the art include: (1) for the space problem of the loudspeaker, a special material that employs zeolite powders as a base material is usually used for volume expansion, which mainly uses the porous structure of zeolite powders to achieve the volume expansion; if the spatial structure of the loudspeaker is regular, the sound-absorbing foam will be applied; (2) for the heat dissipation problem, the current heat dissipation methods of the mobile phone mainly include: thermal conduction, thermal convection, liquid cooling, graphite heat dissipation, and metal back plate heat dissipation, wherein the heat dissipation of thermal conduction mainly uses thermal conductive materials to rapidly transfer heat from the heat source inside the mobile phone to the shell; the thermal conductive materials usually include: graphite, metal plate, silicone grease, heat pipe, electrical conductive foam, etc.; (3) for the signal/magnetic field interference problem, in order to improve the shielding performance and signal output quality of mobile phone, the electrical conductive foam will be affixed to the interior of the mobile phone.

Generally, to solve different problems of the loudspeaker needs different materials or fittings, but the treatment will further occupy the internal space in the loudspeaker.

Therefore, it is necessary to provide a novel material that can simultaneously solve the problems of sound absorption and thermal conductivity and electrical conductivity for loudspeakers.

### SUMMARY

In view of problems in the prior art, an object of the present application is to provide an elastic material and a preparation method therefor and a loudspeaker and an electronic device. The elastic material can simultaneously solve the problems of small internal space, poor heat dissipation, and signal/magnetic field interference in the prior loudspeakers.

To achieve the object, the present application adopts the following technical solutions.

In a first aspect, the present application provides an elastic material. The elastic material comprises a carrying substrate, and a nanomaterial and a molecular sieve arranged inside pores of the carrying substrate.

In the elastic material, the carrying substrate has a content of 97-99 wt %, which can be, for example, 97 wt %, 97.5 wt %, 98 wt %, 98.5 wt %, or 99 wt %; however, the content is not limited to the listed values, and other unlisted values in the numerical range are also applicable.

A mass ratio of the nanomaterial to the molecular sieve is 1:0.9-1.1, which can be, for example, 1:0.9, 1:0.94, 1:0.98, 1:1, 1:1.02, 1:1.06, or 1:1.1; however, the mass ratio is not limited to the listed values, and other unlisted values in the numerical range are also applicable; and preferably the mass ratio is 1:1.

The elastic material provided by the present application has a high specific surface area, which can effectively absorb noise, dissipate acoustic energy, and improve the efficacy of vibration and noise reduction; in addition, loading the nanomaterial and the molecular sieve can further increase the specific surface area of the carrying substrate, thus improving the sound absorption effect, and also endow the elastic material with electrical conductivity and thermal conductivity, so that the problems of small internal space, poor heat dissipation, and signal/magnetic field interference in the prior loudspeakers can be simultaneously solved by one material.

As a preferred technical solution of the present application, the carrying substrate comprises metal foam or sound-absorbing foam.

Preferably, the metal foam has a pore size of 0.05-5.5 mm, which can be, for example, 0.05 mm, 0.1 mm, 0.5 mm, 1 mm, 2 mm, 3 mm, 4 mm, 5 mm, or 5.5 mm; however, the pore size is not limited to the listed values, and other unlisted values in the numerical range are also applicable.

Preferably, the metal foam has a porosity of 57-93%, which can be, for example, 57%, 60%, 65%, 70%, 75%, 80%, 85%, 90%, or 93%; however, the porosity is not limited to the listed values, and other unlisted values in the numerical range are also applicable.

Preferably, the sound-absorbing foam has a pore size of 0.05-5.5 mm, which can be, for example, 0.05 mm, 0.1 mm, 0.5 mm, 1 mm, 2 mm, 3 mm, 4 mm, 5 mm, or 5.5 mm; however, the pore size is not limited to the listed values, and other unlisted values in the numerical range are also applicable.

Preferably, the sound-absorbing foam has a porosity of 57-93%, which can be, for example, 57%, 60%, 65%, 70%, 75%, 80%, 85%, 90%, or 93%; however, the porosity is not limited to the listed values, and other unlisted values in the numerical range are also applicable.

In the present application, the metal foam or the sound-absorbing foam as a carrying substrate is required to have excellent carrying capacity; if the pore size of the carrying substrate is too small, the pore will be blocked in the loading process, thus affecting the performance of the obtained elastic material; if the pore size is too large, the content of the nanomaterial or the molecular sieve loaded in the carrying substrate will be low, thus affecting the performance of the obtained elastic material.

As a preferred technical solution of the present application, the nanomaterial comprises any one or a combination of at least two of a silver nanowire, a cobalt nanowire, a nickel nanowire, a copper nanowire, an iron nanowire, a gold nanowire, a carbon nanotube, or a ceramic nanofiber, and the typical but non-limiting combination comprises a combination of a silver nanowire and a copper nanowire, a combination of a cobalt nanowire, a nickel nanowire, and an iron nanowire, a combination of a copper nanowire and a gold nanowire, or a combination of a carbon nanotube and a ceramic nanofiber.

It should be noted that the nanomaterial in the present application not only improves the sound-absorbing effect by increasing the specific surface area of the carrying substrate via loading, but also achieves the electrical conductivity and thermal conductivity; the non-metallic carbon nanotube and ceramic nanofiber further reduce the interference of antennas in the electronic device.

Preferably, the molecular sieve comprises a pure silicon molecular sieve.

In a second aspect, the present application provides a preparation method for the elastic material according to the first aspect, and the preparation method comprises the following steps:
(1) mixing a nanomaterial, ethanol, and pure water to obtain a nanomaterial solution;
(2) performing a first loading treatment on a carrying substrate for a plurality of times to obtain a semi-finished material;
the first loading treatment comprises: immersing the carrying substrate in the nanomaterial solution obtained in step (1), taking out, and then performing a standing treatment and a drying treatment in sequence; and
(3) performing a second loading treatment on the semi-finished material obtained in step (2) for a plurality of times to obtain the elastic material;
the second loading treatment comprises: immersing the semi-finished material obtained in step (2) in an molecular sieve aqueous solution, taking out, and then performing a drying treatment.

In the present application, the nanomaterial is loaded in the pores of the carrying substrate by the first loading treatment, increasing the surface area of the porous structure in the elastic material, realizing the optimization of sound-absorbing performance of the elastic material; meanwhile, due to its high thermal conductivity and electrical conductivity, the nanomaterial can also optimize the thermal conductivity and electrical conductivity of the elastic material. Then the molecular sieve is loaded in the pores of the carrying substrate by the second loading treatment so as to realize the optimization of the sound absorption and thermal conductivity of the elastic material.

The preparation method in the present application has a simple process and low time consumption, and is conducive to industrial production.

As a preferred technical solution of the present application, based on a mass percentage being 100%, the nanomaterial solution comprises: 0.5-3 wt % of the nanomaterial, 60-85 wt % of ethanol, and 0-30 wt % (excluding 0) of pure water.

Exemplarily, the nanomaterial in the nanomaterial solution has a content of 0.5-3 wt %, which can be, for example, 0.5 wt %, 1 wt %, 1.5 wt %, 2 wt %, 2.5 wt %, or 3 wt %; however, the content is not limited to the listed values, and other unlisted values in the numerical range are also applicable.

The ethanol in the nanomaterial solution has a content of 60-85 wt %, which can be, for example, 60 wt %, 65 wt %, 70 wt %, 75 wt %, 80 wt %, or 85 wt %; however, the content is not limited to the listed values, and other unlisted values in the numerical range are also applicable.

The pure water in the nanomaterial solution has a content of 0-30 wt %, which can be, for example, 2 wt %, 5 wt %, 10 wt %, 15 wt %, 20 wt %, 25 wt %, or 30 wt %; however, the content is not limited to the listed values, and other unlisted values in the numerical range are also applicable.

Preferably, the nanomaterial has a diameter of 10-80 nm, which can be, for example, 10 nm, 20 nm, 30 nm, 40 nm, 50 nm, 60 nm, 70 nm, or 80 nm; however, the diameter is not limited to the listed values, and other unlisted values in the numerical range are also applicable.

In the present application, the diameter of the nanomaterial is 10-80 nm, if the diameter of the nanomaterial is small, the content of the nanomaterial loaded in the pores of the carrying substrate will be small, which will affect the performance of the elastic material; if the diameter of the nanomaterial is large, the pores will be blocked in the loading process.

As a preferred technical solution of the present application, the plurality of times in step (2) is 2-3 times, which can be, for example, 2 times or 3 times.

Preferably, the immersion in step (2) is performed for a period of 5-6 min, which can be, for example, 5 min, 5.2 min, 5.4 min, 5.6 min, 5.8 min, or 6 min; however, the period is not limited to the listed values, and other unlisted values in the numerical range are also applicable.

Preferably, the standing treatment in step (2) is performed for a period of 30-40 s, which can be, for example, 30 s, 32 s, 34 s, 36 s, 38 s, or 40 s; however, the period is not limited to the listed values, and other unlisted values in the numerical range are also applicable.

It should be noted that a platform used for the standing treatment in step (2) of the present application is a screen.

Preferably, the drying treatment in step (2) is performed at a temperature of 97-103° C., which can be, for example, 97° C., 98° C., 99° C., 100° C., 101° C., 102° C., or 103° C.; however, the temperature is not limited to the listed values, and other unlisted values in the numerical range are also applicable.

Preferably, the drying treatment in step (2) is performed for a period of 9-11 min, which can be, for example, 9 min, 9.4 min, 9.8 min, 10.2 min, 10.6 min, or 11 min; however, the period is not limited to the listed values, and other unlisted values in the numerical range are also applicable.

It should be noted that by controlling the repetition number and standing time of the first loading treatment in step (2) and the nanomaterial concentration of the nanomaterial solution in step (1), a sufficient amount of the nanomaterial can be adsorbed into the pores of the carrying substrate without causing pore blocking.

As a preferred technical solution of the present application, the plurality of times in step (3) is 2-4 times, which can be, for example, 2 times, 3 times, or 4 times.

Preferably, the molecular sieve aqueous solution in step (3) comprises a pure silicon molecular sieve and water.

Preferably, a mass ratio of the pure silicon molecular sieve to the water is 1:8-10, which can be, for example, 1:8, 1:8.4, 1:8.8, 1:9.2, 1:9.6, or 1:10; however, the mass ratio is not limited to the listed values, and other unlisted values in the numerical range are also applicable.

Preferably, the pure silicon molecular sieve has a particle size of 200-500 nm, which can be, for example, 200 nm, 250 nm, 300 nm, 350 nm, 400 nm, 450 nm, or 500 nm; however, the particle size is not limited to the listed values, and other unlisted values in the numerical range are also applicable.

As a preferred technical solution of the present application, the immersion in step (3) is performed for a period of 5-6 min, which can be, for example, 5 min, 5.2 min, 5.4 min, 5.6 min, 5.8 min, or 6 min; however, the period is not limited to the listed values, and other unlisted values in the numerical range are also applicable.

Preferably, a first immersion in the second loading treatment in step (3) is accompanied by ultrasonic vibration.

Preferably, the ultrasonic vibration is performed for a period of 2-3 min, which can be, for example, 2 min, 2.2 min, 2.4 min, 2.6 min, 2.8 min, or 3 min; however, the period is not limited to the listed values, and other unlisted values in the numerical range are also applicable.

It should be noted that in the second loading treatment in step (3) of the present application, only the first immersion is accompanied by ultrasonic vibration, which is intended to accelerate the liquid flow of the molecular sieve aqueous solution, and accelerate the bonding between the molecular sieve and the carrying substrate.

Preferably, the drying treatment in step (3) is performed at a temperature of 97-103° C., which can be, for example, 97° C., 98° C., 99° C., 100° C., 101° C., 102° C., or 103° C.; however, the temperature is not limited to the listed values, and other unlisted values in the numerical range are also applicable.

Preferably, the drying treatment in step (3) is performed for a period of 9-11 min, which can be, for example, 9 min, 9.4 min, 9.8 min, 10.2 min, 10.6 min, or 11 min; however, the period is not limited to the listed values, and other unlisted values in the numerical range are also applicable.

As a preferred technical solution of the present application, the preparation method of the elastic material provided by the second aspect comprises the following steps:
(1) mixing a nanomaterial, ethanol and pure water to obtain a nanomaterial solution;
wherein based on a mass percentage being 100%, the nanomaterial solution comprises: 0.5-3 wt % of the nanomaterial, 60-85 wt % of the ethanol, and 0-30 wt % of the pure water; the nanomaterial has a diameter of 10-80 nm;
(2) performing a first loading treatment on a carrying substrate for 2-3 times to obtain a semi-finished material;
the first loading treatment comprises: immersing the carrying substrate in the nanomaterial solution obtained in step (1) for 5-6 min, then taking out, and then laying on a screen for 30-40 s, and drying at 97-103° C. for 9-11 min; and
(3) performing a second loading treatment on the semi-finished material obtained in step (2) for 2-4 times to obtain the elastic material;
the second loading treatment comprises: immersing the semi-finished material obtained in step (2) in an molecular sieve aqueous solution for 5-6 min, then taking out, and drying at 97-103° C. for 9-11 min;
wherein a first immersion in the second loading treatment is accompanied by ultrasonic vibration, and the ultrasonic vibration is performed for a period of 2-3 min.

In a third aspect, the present application provides a loudspeaker, wherein a rear cavity of the loudspeaker is equipped with the elastic material according to the first aspect.

In a fourth aspect, the present application provides an electronic device, wherein a rear cavity of a loudspeaker in the electronic device is equipped with the elastic material according to the first aspect.

The electronic device comprises any one of a smartphone, TWS earphones, a headset, smart glasses, a smartwatch, a VR device, an AR device, a tablet computer, or a laptop computer.

The numerical range in the present application comprises not only the above listed point values, but also any unlisted point values within the above numerical range, and for the reason of space and brevity, the present application will not exhaustively list the specific point values within the range.

### DETAILED DESCRIPTION

The technical solutions of the present application are further described below via specific embodiments. It should be understood by those skilled in the art that the embodiments are merely intended to understand the present application and should not be regarded as specific limitations of the present application.

### Example 1

The example provides an elastic material, and the elastic material comprises a carrying substrate, and a nanomaterial and a molecular sieve arranged inside pores of the carrying substrate;
the carrying substrate in the elastic material has a content of 98 wt %;
a mass ratio of the nanomaterial to the molecular sieve is 1:1.

The preparation method for the elastic material in this example comprises the following steps:
(1) a nanomaterial, ethanol and pure water were mixed to obtain a nanomaterial solution;
wherein based on a mass percentage being 100%, the nanomaterial solution comprised: 1 wt % of the silver nanowire, 75 wt % of ethanol, and 24 wt % of pure water; the nanomaterial had a diameter of 45 nm;
(2) a first loading treatment was performed for 2 times on metal foam with a pore size of 4.5-5.5 mm and a porosity of 85% to obtain a semi-finished material;
the first loading treatment comprised: the carrying substrate was immersed in the nanomaterial solution obtained in step (1) for 5 min, then taken out, and then allowed to stand on a screen for 30 s, and dried at 100° C. for 10 min; and
(3) a second loading treatment was performed for 4 times on the semi-finished material obtained in step (2) to obtain the elastic material;
the second loading treatment comprised: the semi-finished material obtained in step (2) was immersed in a molecular sieve aqueous solution for 5 min, then taken out, and dried at 100° C. for 10 min;
wherein a first immersion in the second loading treatment was accompanied by ultrasonic vibration, and the ultrasonic vibration was performed for a period of 3 min.

### Example 2

The example provides an elastic material, and the elastic material comprises a carrying substrate, and a nanomaterial and a molecular sieve arranged inside pores of the carrying substrate;
the carrying substrate in the elastic material has a content of 97 wt %;
a mass ratio of the nanomaterial to the molecular sieve is 1:0.9.

The preparation method for the elastic material in this example comprises the following steps:
(1) a nanomaterial, ethanol, and pure water were mixed to obtain a nanomaterial solution;
wherein based on a mass percentage being 100%, the nanomaterial solution comprised: 0.5 wt % of the copper nanowire, 85 wt % of ethanol, and 14.5 wt % of pure water; the nanomaterial had a diameter of 10 nm;
(2) a first loading treatment was performed for 2 times on the carrying substrate to obtain a semi-finished material;
the first loading treatment comprised: the carrying substrate was immersed in the nanomaterial solution obtained in step (1) for 6 min, then taken out, and then allowed to stand on a screen for 35 s, and dried at 97° C. for 11 min; and
(3) a second loading treatment was performed for 2 times on the semi-finished material obtained in step (2) to obtain the elastic material;
the second loading treatment comprised: the semi-finished material obtained in step (2) was immersed in a molecular sieve aqueous solution for 6 min, then taken out, and dried at 97° C. for 11 min;
wherein a first immersion in the second loading treatment was accompanied by ultrasonic vibration, and the ultrasonic vibration was performed for a period of 2 min.

### Example 3

The example provides an elastic material, and the elastic material comprises a carrying substrate, and a nanomaterial and a molecular sieve arranged inside pores of the carrying substrate;
the carrying substrate in the elastic material has a content of 99 wt %;
a mass ratio of the nanomaterial to the molecular sieve is 1:1.1.

The preparation method for the elastic material in this example comprises the following steps:
(1) a nanomaterial, ethanol, and pure water were mixed to obtain a nanomaterial solution;
wherein based on a mass percentage being 100%, the nanomaterial solution comprised: 3 wt % of the carbon nanotube, 67 wt % of ethanol, and 30 wt % of pure water; the nanomaterial had a diameter of 80 nm;
(2) a first loading treatment was performed for 2 times on the carrying substrate to obtain a semi-finished material;
the first loading treatment comprised: the carrying substrate was immersed in the nanomaterial solution obtained in step (1) for 5.5 min, then taken out, and then allowed to stand on a screen for 40 s, and dried at 103° C. for 9 min; and
(3) a second loading treatment was performed for 3 times on the semi-finished material obtained in step (2) to obtain the elastic material;
the second loading treatment comprised: the semi-finished material obtained in step (2) was immersed in a molecular sieve aqueous solution for 5.5 min, then taken out, and dried at 103° C. for 9 min;
wherein a first immersion in the second loading treatment was accompanied by ultrasonic vibration, and the ultrasonic vibration was performed for a period of 2.5 min.

### Example 4

The example provides an elastic material, and the elastic material comprises a carrying substrate, and a nanomaterial and a molecular sieve arranged inside pores of the carrying substrate;
the carrying substrate in the elastic material has a content of 98 wt %;
a mass ratio of the nanomaterial to the molecular sieve is 1:1.

The preparation method for the elastic material in this example differs from Example 1 only in that:
in this example, the content of the silver nanowire in the nanomaterial solution in step (1) was adjusted to 4.5 wt %.

### Example 5

The example provides an elastic material, and the elastic material comprises a carrying substrate, and a nanomaterial and a molecular sieve arranged inside pores of the carrying substrate;
the carrying substrate in the elastic material has a content of 98 wt %;
a mass ratio of the nanomaterial to the molecular sieve is 1:1.

The preparation method for the elastic material in this example differs from Example 1 only in that:
in this example, the period of the standing treatment in step (2) was adjusted to 50 s.

### Example 6

The example provides an elastic material, and the elastic material comprises a carrying substrate, and a nanomaterial and a molecular sieve arranged inside pores of the carrying substrate;
the carrying substrate in the elastic material has a content of 98 wt %;
a mass ratio of the nanomaterial to the molecular sieve is 1:1.

The preparation method for the elastic material in this example differs from Example 1 only in that:
in this example, the period of the standing treatment in step (2) was adjusted to 20 s.

### Example 7

The example provides an elastic material, and the elastic material comprises a carrying substrate, and a nanomaterial and a molecular sieve arranged inside pores of the carrying substrate;
the carrying substrate in the elastic material has a content of 98 wt %;
a mass ratio of the nanomaterial to the molecular sieve is 1:1.

The preparation method for the elastic material in this example differs from Example 1 only in that:
in this example, the first loading treatment in step (2) was performed for 1 time.

### Example 8

The example provides an elastic material, and the elastic material comprises a carrying substrate, and a nanomaterial and a molecular sieve arranged inside pores of the carrying substrate;
the carrying substrate in the elastic material has a content of 98 wt %;
a mass ratio of the nanomaterial to the molecular sieve is 1:1.

The preparation method for the elastic material in this example differs from Example 1 only in that:
in this example, the first loading treatment in step (2) was performed for 4 times.

### Example 9

The example provides an elastic material, and the elastic material comprises a carrying substrate, and a nanomaterial and a molecular sieve arranged inside pores of the carrying substrate;
the carrying substrate in the elastic material has a content of 98 wt %;
a mass ratio of the nanomaterial to the molecular sieve is 1:1.

The preparation method for the elastic material in this example differs from Example 1 only in that:
in this example, after the step (3), the first loading treatment in step (1) was performed twice.

### Example 10

The example provides an elastic material, and the elastic material comprises a carrying substrate, and a nanomaterial and a molecular sieve arranged inside pores of the carrying substrate;
the carrying substrate in the elastic material has a content of 98 wt %;
a mass ratio of the nanomaterial to the molecular sieve is 1:1.

The preparation method for the elastic material in this example differs from Example 1 only in that:
in this example, the second loading treatment in step (3) was performed for 1 time.

### Example 11

The example provides an elastic material, and the elastic material comprises a carrying substrate, and a nanomaterial and a molecular sieve arranged inside pores of the carrying substrate;
the carrying substrate in the elastic material has a content of 98 wt %;
a mass ratio of the nanomaterial to the molecular sieve is 1:1.

The preparation method for the elastic material in this example differs from Example 1 only in that:
in this example, the second loading treatment in step (3) was performed for 5 times.

### Example 12

The example provides an elastic material, and the elastic material comprises a carrying substrate, and a nanomaterial and a molecular sieve arranged inside pores of the carrying substrate;
the carrying substrate in the elastic material has a content of 98 wt %;
a mass ratio of the nanomaterial to the molecular sieve is 1:1.

The preparation method for the elastic material in this example differs from Example 1 only in that:
in this example, the order of steps (2) and (3) was reversed, that is, the molecular sieve was loaded first into the pores of the carrying substrate, and then the nanomaterial was loaded.

### Comparative Example 1

This comparative example provides an elastic material, and the elastic material differs from Example 1 only in that:
in this comparative example, the nanomaterial to be loaded inside the pores of the carrying substrate was omitted.

The preparation method for the elastic material in this comparative example differs from Example 1 only in that:
in this comparative example, step (2) was omitted.

### Comparative Example 2

This comparative example provides an elastic material, and the elastic material differs from Example 1 only in that:
in this comparative example, the molecular sieve to be loaded inside the pores of the carrying substrate was omitted.

The preparation method for the elastic material in this comparative example differs from Example 1 only in that:
in this comparative example, step (3) was omitted.

The elastic materials provided in partial examples and comparative examples above were tested for the specific surface area. The results are shown in Table 1.

TABLE 1

| | Specific surface area (m²/g) |
|---|---|
| Example 1 | 193.20 |
| Example 2 | 149.45 |
| Example 3 | 176.56 |
| Example 9 | 145.0 |
| Example 10 | 134.33 |
| Comparative Example 2 | 4.45 |

The following can be seen based on Table 1:
(1) it can be seen from a comprehensive analysis of Examples 1-3 that the elastic material provided by the present application has a large specific surface area, which can effectively absorb noise, dissipate acoustic energy, and improve the efficacy of vibration and noise reduction;
in addition, the elastic material provided in Examples 1-3 has excellent electrical conductivity and thermal conductivity, which improves the shielding performance and signal output quality of the electronic device, and solves the problem of reduced service life caused by unefficient heat dissipation of the electronic device;
(2) it can be seen from a comprehensive analysis of Example 1 and Examples 4-6 that the content of the silver nanowire in the nanomaterial solution and the period of the standing treatment in the first loading treatment in step (2) both affect the loading amount of the nanomaterial, thus affecting the performance of the elastic material;
when the content of the silver nanowire in the nanomaterial solution is relatively high, or when the period of the standing treatment is relatively long, the phenomenon of pore blocking occurs, which not only reduces the specific surface area of the elastic material, but also affects the thermal conductivity and electrical conductivity of the elastic material;
when the period of the standing treatment is relatively short, the loading amount of the silver nanowire is low, thus affecting the thermal conductivity and electrical conductivity of the elastic material;
(3) it can be seen from a comprehensive analysis of Example 1 and Examples 7-9 that the execution numbers of the first loading treatment in step (2) affects the loading amount of the nanomaterial, thereby affecting the performance of the elastic material;
when the execution numbers of the first loading treatment is relatively small, the loading amount of the silver nanowire is low, thus affecting the thermal conductivity and electrical conductivity of the elastic material; when the execution numbers of the first loading treatment are high, the phenomenon of pore blocking occurs, which not only reduces the specific surface area of the elastic material, but also affects the thermal conductivity and electrical conductivity of the elastic material;
when the first loading treatment is added after the second loading treatment, the specific surface area of the obtained elastic material does not increase, but has a tendency to decrease, thus affecting the sound absorption effect of the elastic material;
(4) it can be seen from a comprehensive analysis of Example 1 and Examples 10 and 11 that the execution numbers of the second loading treatment in step (3) affects the loading amount of the molecular sieve, thereby affecting the performance of the elastic material;
when the execution numbers of the second loading treatment is relatively small, the loading amount of the molecular sieve is low, thus affecting the optimization of the sound absorption and the thermal conductivity of the elastic material; when the execution numbers of the second loading treatment is high, the pores are prone to be blocked;
(5) it can be seen from a comprehensive analysis of Example 1 and Example 12 that if the molecular sieve with a larger diameter are loaded first and then the nanomaterial are loaded, the loading ratio of the molecular sieve and the nanomaterial in the obtained elastic material will be affected, or even the loading amount of the nanomaterial will be substantially reduced, further affecting the optimization of the electrical conductivity of the elastic material; and
(6) it can be seen from a comprehensive analysis of Example 1 and Comparative Examples 1 and 2 that only when both the nanomaterial and the molecular sieve are contained at the same time can the problems of small internal space, poor heat dissipation, and signal/magnetic field interference be simultaneously solved;
when the loading of the molecular sieve is omitted, the specific surface area of the obtained elastic material is substantially reduced, affecting the performance of the obtained elastic material.

In summary, the elastic material provided by the present application has a large specific surface area, which can effectively absorb noise, dissipate acoustic energy, and improve the efficacy of vibration and noise reduction; and by loading the nanomaterial and the molecular sieve, the shielding performance and signal output quality of the electronic device are improved, and the problem of reduced service life caused by unefficient heat dissipation of the electronic device is solved.

The applicant declares that that the above specific embodiments provide a further detailed description of the objects, technical solutions and beneficial effects of the present application, and it should be understood that the above is only specific embodiments of the present application, and are not intended to limit the present application. Any modification, equivalent substitution, or improvement made within the spirit and principles of the present application shall fall within the protection scope of the present application.

What is claimed is:

1. An elastic material, which comprises a carrying substrate, and a nanomaterial and a molecular sieve arranged inside pores of the carrying substrate;
in the elastic material, the carrying substrate has a content of 97-99 wt %;
a mass ratio of the nanomaterial to the molecular sieve is 1:0.9-1.1.

2. The elastic material according to claim 1, wherein the carrying substrate comprises metal foam or sound-absorbing foam.

3. The elastic material according to claim 1, wherein the carrying substrate comprises metal foam, and the metal foam has a pore size of 0.05-5.5 mm;
the metal foam has a porosity of 57-93%.

4. The elastic material according to claim 1, wherein the carrying substrate comprises sound-absorbing foam, and the sound-absorbing foam has an pore size of 0.05-5.5 mm;
the sound-absorbing foam has a porosity of 57-93%.

5. The elastic material according to claim 1, wherein the nanomaterial comprises any one or a combination of at least two of a silver nanowire, a cobalt nanowire, a nickel nanowire, a copper nanowire, an iron nanowire, a gold nanowire, a carbon nanotube, or a ceramic nanofiber;
the molecular sieve comprises a pure silicon molecular sieve.

6. The elastic material according to claim 2, wherein the nanomaterial comprises any one or a combination of at least two of a silver nanowire, a cobalt nanowire, a nickel nanowire, a copper nanowire, an iron nanowire, a gold nanowire, a carbon nanotube, or a ceramic nanofiber;
the molecular sieve comprises a pure silicon molecular sieve.

7. A preparation method for the elastic material according to claim 1, which comprises the following steps:
(1) mixing the nanomaterial, ethanol, and pure water to obtain a nanomaterial solution;
(2) performing a first loading treatment on the carrying substrate for a plurality of times to obtain a semi-finished material;
the first loading treatment comprises: immersing the carrying substrate in the nanomaterial solution obtained in step (1), taking out, and then performing a standing treatment and a drying treatment in sequence; and
(3) performing a second loading treatment on the semi-finished material obtained in step (2) for a plurality of times to obtain the elastic material;
the second loading treatment comprises: immersing the semi-finished material obtained in step (2) in an molecular sieve aqueous solution, taking out, and then performing a drying treatment.

8. The preparation method according to claim 7, wherein based on a mass percentage being 100%, the nanomaterial solution comprises: 0.5-3 wt % of the nanomaterial, 60-85 wt % of ethanol, and 0-30 wt % of pure water;
the nanomaterial has a diameter of 10-80 nm.

9. The preparation method according to claim 7, wherein the plurality of times in step (2) is 2-3 times;
the immersion in step (2) is performed for a period of 5-6 min;
the standing treatment in step (2) is performed for a period of 30-40 s;
the drying treatment in step (2) is performed at a temperature of 97-103° C.;
the drying treatment in step (2) is performed for a period of 9-11 min.

10. The preparation method according to claim 7, wherein the plurality of times in step (3) is 2-4 times;
the molecular sieve aqueous solution in step (3) comprises a pure silicon molecular sieve and water;
a mass ratio of the pure silicon molecular sieve to the water is 1:8-10;
the pure silicon molecular sieve has a particle size of 200-500 nm.

11. The preparation method according to claim 7, wherein the immersion in step (3) is performed for a period of 5-6 min;
a first immersion in the second loading treatment in step (3) is accompanied by ultrasonic vibration;
the ultrasonic vibration is performed for a period of 2-3 min;
the drying treatment in step (3) is performed at a temperature of 97-103° C.;
the drying treatment in step (3) is performed for a period of 9-11 min.

12. The preparation method according to claim 7, wherein the nanomaterial in step (1) comprises any one or a combination of at least two of a silver nanowire, a cobalt nanowire, a nickel nanowire, a copper nanowire, an iron nanowire, a gold nanowire, a carbon nanotube, or a ceramic nanofiber.

13. The preparation method according to claim 7, wherein the carrying substrate in step (2) comprises metal foam or sound-absorbing foam.

14. The preparation method according to claim 7, wherein the carrying substrate in step (2) comprises metal foam, and the metal foam has a pore size of 0.05-5.5 mm;
the metal foam has a porosity of 57-93%.

15. The preparation method according to claim 7, wherein the carrying substrate in step (2) comprises sound-absorbing foam, and the sound-absorbing foam has an pore size of 0.05-5.5 mm;
the sound-absorbing foam has a porosity of 57-93%.

16. A loudspeaker, wherein a rear cavity of the loudspeaker is equipped with the elastic material according to claim 1.

17. An electronic device, wherein a rear cavity of a loudspeaker in the electronic device is equipped with the elastic material according to claim 1;
the electronic device comprises any one of a smartphone, TWS earphones, a headset, smart glasses, a smartwatch, a VR device, an AR device, a tablet computer, or a laptop computer.
